(19) United States
(12) Patent Application Publication
(10) Pub. No.: US 2025/0385423 A1
(43) Pub. Date: Dec. 18, 2025

(54) ANTENNA PACKAGE

(71) Applicant: Qorvo US, Inc., Greensboro, NC (US)

(72) Inventors: Anthony Chiu, Richardson, TX (US); Andrew Arthur Ketterson, Dallas, TX (US); Bror Peterson, Fairview, TX (US)

(21) Appl. No.: 19/083,684

(22) Filed: Mar. 19, 2025

Related U.S. Application Data
(60) Provisional application No. 63/659,952, filed on Jun. 14, 2024.

(51) Int. Cl. H01Q 1/22; H01Q 1/02; H01Q 9/04; H01Q 21/06

(52) U.S. Cl. CPC H01Q 1/2283; H01Q 1/02; H01Q 9/0407; H01Q 21/065

(57) ABSTRACT

An antenna package is disclosed. The antenna package includes a beam former circuit, a second die with an integrated circuit that may have power amplifier circuitry, and an antenna array. The antenna package is assembled into a multilayer substrate with the die on a first level with externally accessible contact points. The second die may be positioned within the substrate with no externally accessible contact points and be coupled to the first die, with vias having little or no lateral translation of signal paths on metal layers of the substrate. The antenna array may be positioned on a top layer opposite the first layer and thus be positioned to radiate effectively for signal transmission (or receive signal without obstruction from the package). The antenna array may likewise be coupled to the second die, with vias having little or no lateral translation of signal paths on metal layers of the substrate.

### PRIORITY APPLICATION

The present application claims priority to U.S. Provisional Patent Application Ser. No. 63/659,952, entitled ANTENNA PACKAGE, filed on Jun. 14, 2024, the contents of which is hereby incorporated by reference in its entirety.

### BACKGROUND

### I. Field of the Disclosure

The technology of the disclosure relates generally to antennas for wireless transceivers and, more particularly, to assembling a package for an antenna and supporting circuitry.

### II. Background

Communication devices and other devices that rely on the ability to send and receive wireless signals abound in modern society, ranging from the ubiquitous mobile terminals (e.g., cell phones and laptops) working with household wireless routers to base stations and more esoteric applications such as radar for vehicles (e.g., cars, planes, airports, and the like). In the wireless context, signals are sent and received through an antenna. Commercial pressures require increasingly more efficient operation. Making the path for signals to travel to and from the antennas more efficient provides room for innovation.

### SUMMARY

Aspects disclosed in the detailed description include an antenna package. In particular, an antenna package is well suited for use in antenna array applications and may include a first die that may include a beam former circuit, a second die with an integrated circuit that may have, for example, power amplifier circuitry (e.g., a monolithic microwave integrated circuit), and an antenna array. The antenna package is assembled into a multilayer substrate with the first die being on a first level with externally accessible contact points. The second die may be positioned within the substrate with no externally accessible contact points and be coupled to the first die with vias having little or no lateral translation of signal paths on intervening metal layers of the substrate. The antenna array may be positioned on a top layer opposite the first layer and thus be positioned to radiate effectively for signal transmission (or receive signal without obstruction from the package). The antenna array may likewise be coupled to the second die with vias having little or no lateral translation of signal paths on intervening metal layers of the substrate. The effect of the vertical stacking of dies and antennas with the vias means that the overall signal path is shortened, and transmission losses from the resistance of the signal path are minimized, resulting in greater efficiency.

In this regard, in one aspect, a package is disclosed. The package includes a first side comprising one or more external input/output (I/O) contacts configured to couple electrically to complementary contacts on a substrate and one or more internal I/O contacts. The package also includes a first metal layer coupling at least one external I/O contact to at least one internal I/O contact, a first die electrically coupled to at least one internal I/O contact and the first side, and a second side opposite the first side. The package further includes an antenna attached to the second side and a second die positioned between the first metal layer and the second side, the second die electrically coupled to the first die directly by vias with no lateral translation for signal paths between the first die and the second die, the second die electrically coupled to the antenna.

In another aspect, a wireless communication device is disclosed. The wireless communication device includes a baseband processor (BBP) and an antenna package communicatively coupled to the BBP. The antenna package comprising a first side comprising one or more external input/output (I/O) contacts configured to couple electrically to the BBP through a substrate and one or more internal I/O contacts. The antenna package also includes a first metal layer coupling at least one external I/O contact to at least one internal I/O contact, a first die electrically coupled to the one or more internal I/O contacts and the first side, and a second side opposite the first side. The antenna package also includes an antenna attached to the second side and a second die positioned between the first metal layer and the second side, the second die electrically coupled to the first die directly by vias with no lateral translation for signal paths between the first die and the second die, the second die electrically coupled to the antenna.

### BRIEF DESCRIPTION OF THE DRAWINGS

FIG. 1 is a block diagram of a wireless device having transmission and receive paths working with an antenna array;

FIG. 2A is a side elevational view of the components of the wireless device of FIG. 1 on a substrate in a conventional arrangement;

FIG. 2B is a side elevational view of the components of the wireless device of FIG. 1 in a conventional package;

FIG. 3 is a side elevational view of an antenna package embodying the wireless device of FIG. 1 according to aspects of the present disclosure;

FIG. 4A-4F are top plan views of layers within the package of FIG. 3;

FIG. 5 is a perspective view of a first die coupling to a bottom layer of the package;

FIG. 6A is a perspective view of a heat spreader layer that may be positioned on a top of the package;

FIG. 6B is a perspective view of the heat spreader layer of FIG. 6A coupled with an antenna array;

FIG. 7A is a transparent perspective view of the package of the present disclosure without the heat spreader of FIGS. 6A & 6B; and

FIG. 7B is the package of FIG. 7A with the heat spreader added.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that although the terms first, second, etc. may be used herein to describe various elements, these elements should not be limited by these terms. These terms are only used to distinguish one element from another. For example, a first element could be termed a second element, and similarly, a second element could be termed a first element without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element, or intervening elements may also be present. In contrast, when an element is referred to as being “directly on” or extending “directly onto” another element, no intervening elements are present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, no intervening elements are present. It will also be understood that when an element is referred to as being “connected” or “coupled” to another element, it can be directly connected or coupled to the other element, or intervening elements may be present. In contrast, when an element is referred to as being “directly connected” or “directly coupled” to another element, no intervening elements are present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In keeping with the above admonition about definitions, the present disclosure uses transceiver in a broad manner. Current industry literature uses “transceiver” in two ways. The first way uses transceiver broadly to refer to a plurality of circuits that send and receive signals. Exemplary circuits may include a baseband processor, an up/down conversion circuit, filters, amplifiers, couplers, and the like coupled to one or more antennas. A second way, used by some authors in the industry literature, refers to a circuit positioned between a baseband processor and a power amplifier circuit as a transceiver. This intermediate circuit may include the up/down conversion circuits, mixers, oscillators, filters, and the like but generally does not include the power amplifiers. As used herein, the term transceiver is used in the first sense. Where relevant to distinguish between the two definitions, the terms “transceiver chain” and “transceiver circuit” are used respectively.

Additionally, to the extent that the term “approximately” is used in the claims, it is herein defined to be within five percent (5%).

Aspects disclosed in the detailed description include an antenna package. In particular, an antenna package is well suited for use in antenna array applications and may include a first die that may include a beam former circuit, a second die with an integrated circuit that may have, for example, power amplifier circuitry (e.g., a monolithic microwave integrated circuit), and an antenna array. The antenna package is assembled into a multilayer substrate, with the first die being on a first level with externally accessible contact points. The second die may be positioned within the substrate with no externally accessible contact points and be coupled to the first die with vias having little or no lateral translation of signal paths on intervening metal layers of the substrate. The antenna array may be positioned on a top layer opposite the first layer and thus be positioned to radiate effectively for signal transmission (or receive signal without obstruction from the package). The antenna array may likewise be coupled to the second die, with vias having little or no lateral translation of signal paths on intervening metal layers of the substrate. The effect of the vertical stacking of dies and antennas with the vias means that the overall signal path is shortened and transmission losses from the resistance of the signal path is minimized resulting in greater efficiency.

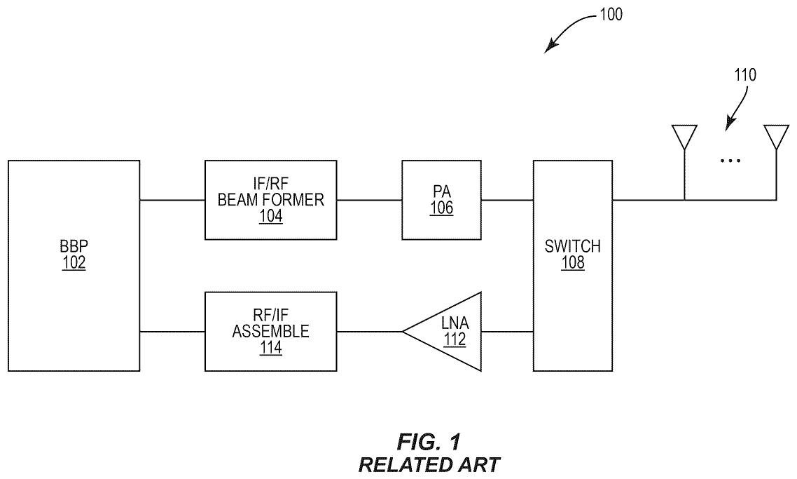

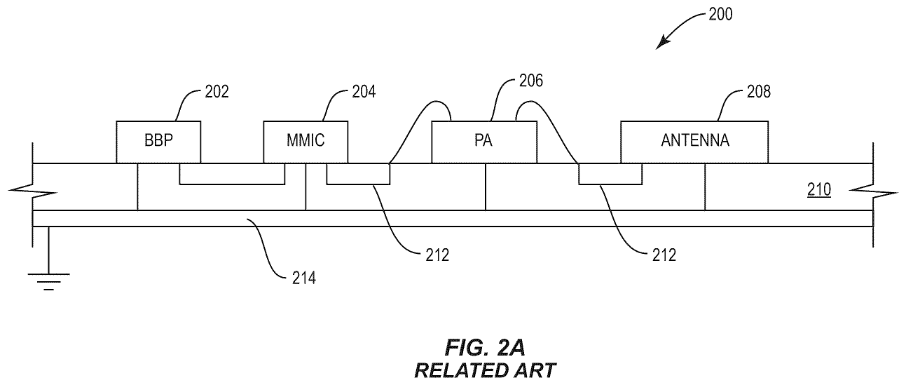

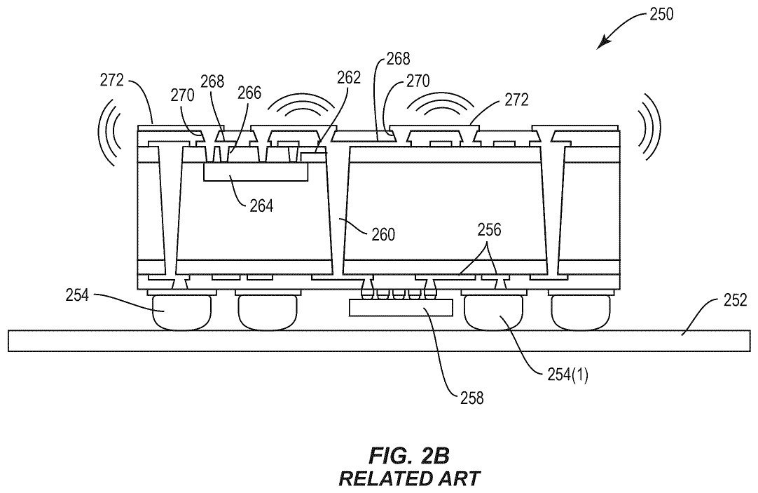

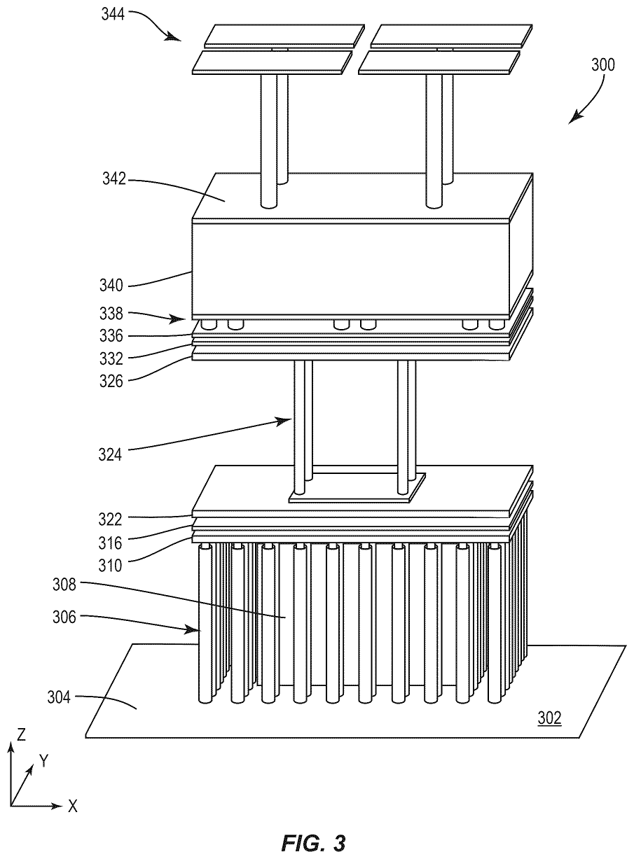

Before addressing aspects of the present disclosure, a brief overview of a wireless device is provided with reference to FIG. 1, along with a discussion of conventional approaches to assembling the components of the wireless device with reference to FIGS. 2A & 2B. A discussion of aspects of the present disclosure begins below with reference to FIG. 3.

In this regard, FIG. 1 is a block diagram of a wireless device 100. The wireless device 100 may be wireless infrastructure such as a base station, a wireless router, or the like. Further applications include defense, vehicular, or aviation uses (e.g., radar systems or the like). While less useful for mobile terminals such as cellular phones or laptops, the present disclosure could be used therein and is not specifically excluded. The wireless device 100 may include a baseband processor (BBP) 102, which generates signals to be transmitted and processes received signals at low (i.e., baseband) frequencies. The BBP 102 may output intermediate frequency signals to an intermediate circuit 104 (Beam Former Integrated Circuit, BFIC). The signals to be transmitted may be upconverted to radio frequencies (RF) from the intermediate frequency and/or formed into beams by the intermediate circuit 104, which may be a transceiver circuit as defined above. A front-end module 106 may include a power amplifier (e.g., amplifiers, bias circuits, and the like) to boost signals to be transmitted to desired levels. The boosted signals may pass through a switch 108 to an antenna array 110, which transmits multiple beams as indicated by the beam forming previously performed.

On the receive side, signals impinge on the antenna array 110 and are passed to the switch 108, which routes them to an antenna circuit 112 (e.g., low noise amplifier (LNA)) and then to an intermediate circuit 114, which downconverts RF signals to intermediate frequencies for further processing by the BBP 102. It is possible that the intermediate circuits 104 and 114 are instantiated in a single die (e.g., a BFIC).

It should be appreciated that the above discussion is greatly simplified. Different circuits may be analog or digital and may be implemented in different technologies (e.g., field effect transistors (FETs) or bipolar junction transistors (BJTs)). Further, different functions may be distributed between different circuits (e.g., the BBP may upconvert to RF, and the intermediate circuits only handle beam forming and beam assembly).

In the past, the different technologies have caused different elements to be distributed between multiple dies. Assembling these multiple dies was initially done with separate dies on a single substrate, as illustrated in FIG. 2, where the device 200 has a BBP die 202, a monolithic microwave integrated circuit (MMIC) 204, a power amplifier or radio frequency integrated circuit (RFIC) 206, and antenna array 208 mounted on a substrate 210 with conductors 212 either placed on the surface of the substrate 210 or embedded therein (as shown). A ground plane 214 may be positioned on an opposite side of the substrate 210. While this is an adequate approach to get the desired functionality, commercial pressure to reduce the overall footprint means that this approach is not commercially practical.

FIG. 2B illustrates an early effort to assemble an antenna package 250 mounted on a substrate 252, which may be a printed circuit board (PCB) or the like. The antenna package 250 is mounted on the substrate 252 with a ball grid array (BGA) package 254, allowing signals to pass from the substrate 252 into interior metal layers 256 laterally (e.g., from BGA ball 254(1)) to an IC 258 (e.g., an MMIC). After processing in the IC 258, signals are then routed through vias 260 to other internal metal layers 262 and then laterally to a second IC 264 (e.g., an RFIC). After processing in the second IC 264, the signals are then passed through additional vias 266 to internal metal layers 262, 268 and moved laterally to vias 270 to antennas 272.

While there are other packaging approaches, all the approaches known to the authors require lateral translation through the internal metal layers. Such lateral translation imposes an efficiency penalty on the movement of the signals. That is, the conductors through which the signals pass have a resistance which is a function of cross-sectional area and distance. Thus, the longer the distance, the greater the resistance. The greater the resistance, the more waste heat that is generated as power is used inside the package instead of being transmitted through the antenna. At certain frequencies of interest (e.g., microwave), these resistance penalties may be substantial.

Aspects of the present disclosure provide an improved antenna package that minimizes the lateral distance the signals must pass within the antenna package. Specifically, incoming signals pass to the first die, where initial processing is performed, then exit the first die through vias and go straight to the second die. Processing within the second die occurs, and the signals exit through the opposite side of the second die to the second vias, which take the signals straight to the antenna array.

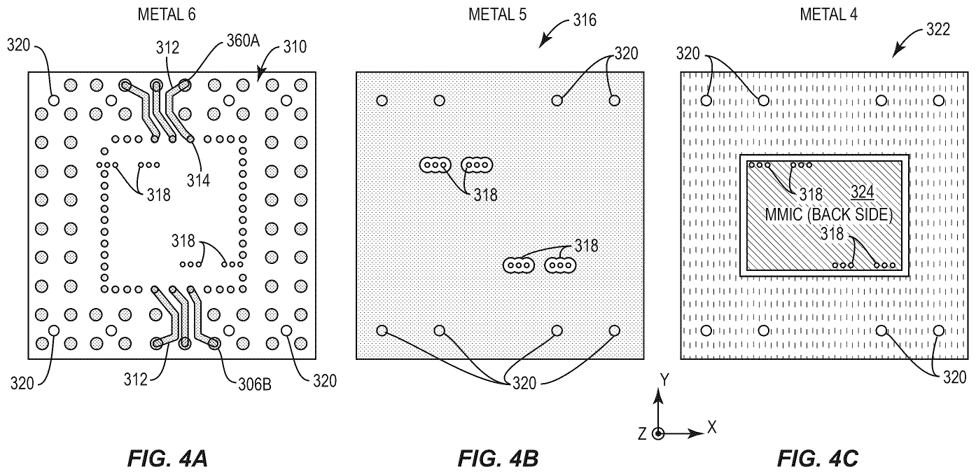

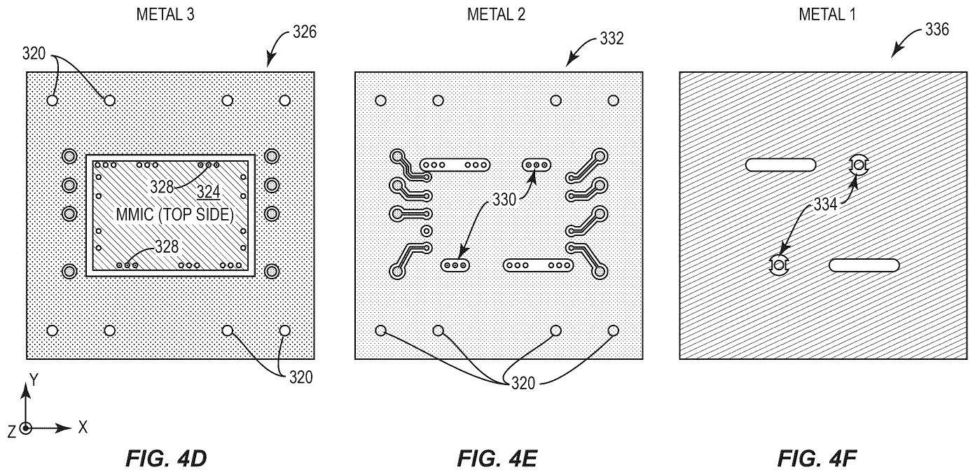

In this regard, FIG. 3 illustrates a cross-sectional view of a package 300 according to aspects of the present disclosure. Because of the multi-layer structure, some elements are not readily seen in FIG. 3. FIGS. 4A-5 provide additional views, which help supplement the understanding of the relative positions of various items. The package 300 may be mounted on a substrate 302 with conductors 304 thereon. The substrate 302 may be a PCB or the like. The package 300 includes a BGA 306, which has balls of sufficient height (in the z-axis direction) greater than a first die 308. Conductors 304 couple to balls in the BGA 306 and allow signals to pass therethrough to a first metal layer 310 (metal 6, see FIG. 4A). Within the first metal layer 310, internal conductors 312 do provide some lateral translation from the ball contacts 306A of the BGA 306 to contacts 314 for the first die 308. The first die 308 hangs “below” (in the z-axis) the first metal layer 310 nestled in the BGA 306. This arrangement is better seen in FIG. 5.

Unlabeled dielectric material may be positioned above (in the z-axis) the first metal layer and have a second metal layer 316 (metal 5, see FIG. 4B) thereon. While not shown in FIG. 3, vias 318 couple the first die 308 through the first metal layer 310 and the second metal layer 316. The second metal layer 316 may act as a ground plane and have vias 320 to couple the second metal layer 316 to a ground plane (not shown) in the substrate 302.

A third metal layer 322 (metal 4, see FIG. 4C) may terminate the vias 318 and support a second die 324 (e.g., the MMIC). The second die 324 sits within an aperture defined by the dielectric material of the package 300 and may perform additional processing steps (e.g., amplification, predistortion, or the like) on the signals received through the vias 318.

A fourth metal layer 326 (metal 3, see FIG. 4D) may rest on top of the second die 324 and have contacts 328 that carry the signals upward (in the z-axis) to vias 330. That is, the second die 324 has contacts on top and bottom that couple up and down.

The vias 330 pass through a fifth metal layer 332 (metal 2, see FIG. 4E) to pass the signal to solder pads 334 in a sixth metal layer 336 (metal 1, see FIG. 4F). Note that while six metal layers are shown herein, it should be appreciated that more (or potentially fewer) metal layers may be used without departing from the present disclosure.

An interface layer 338 may be positioned on top of the sixth metal layer 336 (with or without dielectric material). A thermal dissipation layer 340 may be positioned on the interface layer 338. In an exemplary aspect, the thermal dissipation layer 340 may be aluminum nitride. A ground reflector 342 may be positioned on the thermal dissipation layer 340, and the antenna array 344 may be positioned thereabove.

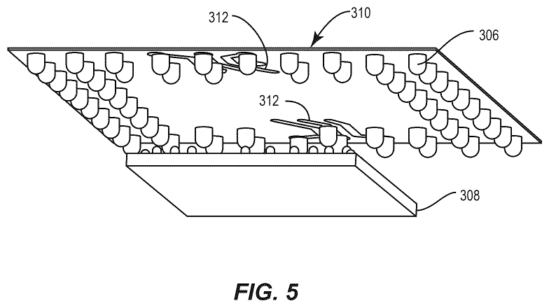

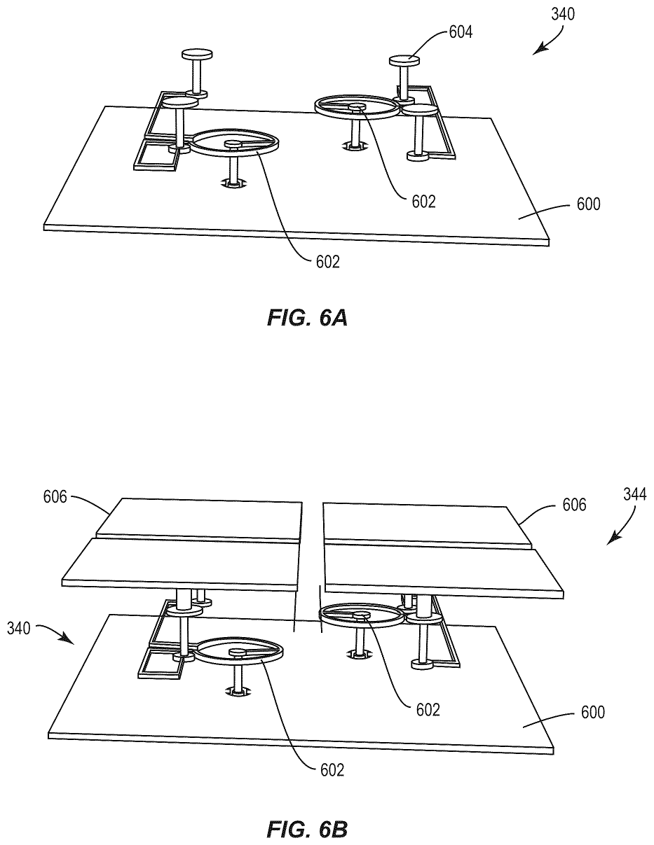

Additional details about the thermal dissipation layer 340 and the antenna array 344 can be seen in FIGS. 6A & 6B. Specifically, the thermal dissipation layer 340 may include a ground plane 600 with matching solder pads to align with solder pads 334 (of FIG. 4F). There may be a power divider/combiner layer 602 and a mounting pad layer 604 that provides mounting pads for the antennas 606 (FIG. 6B). In an exemplary aspect, the antennas 606 are patch antennas.

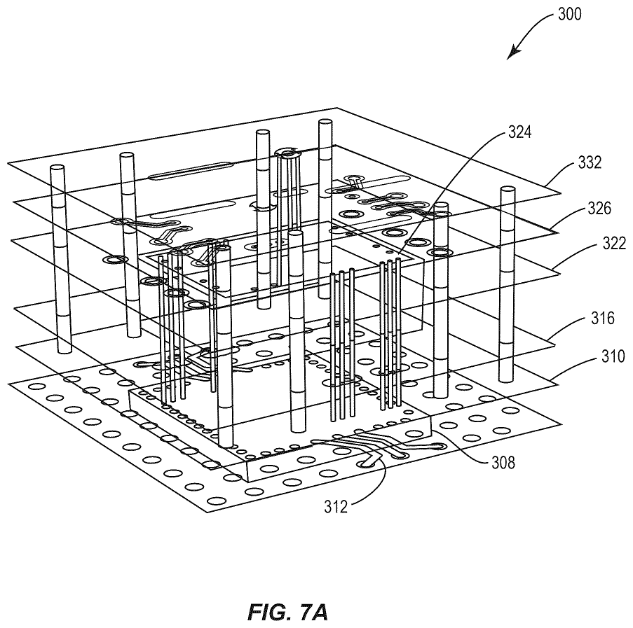

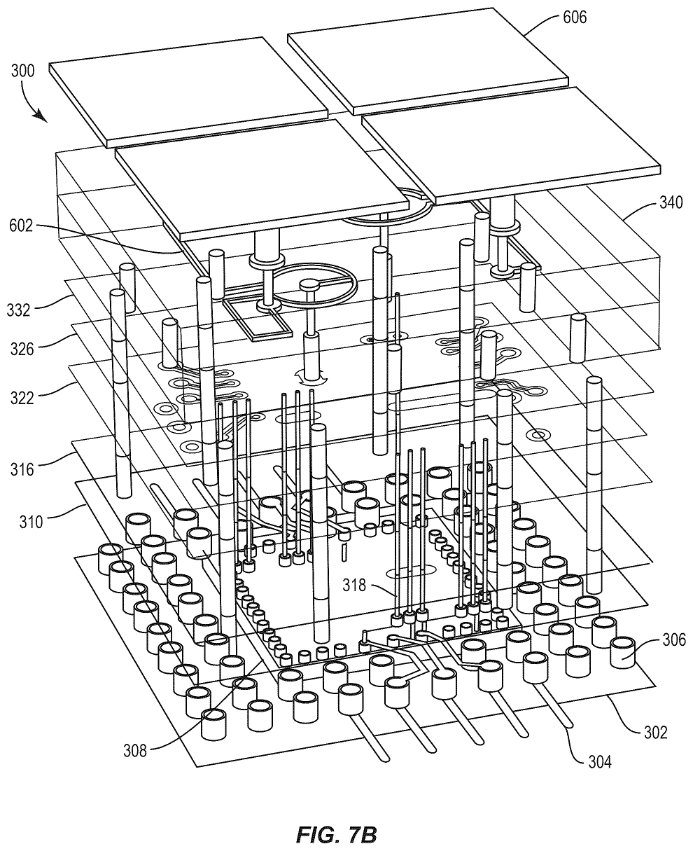

FIGS. 7A & 7B are provided to assist in conceptualizing the package 300 with the understanding that these figures are somewhat cluttered and thus are best considered in conjunction with the individual layer discussion provided above.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications, as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein but is to be accorded the widest scope consistent with the principles and novel features disclosed herein.

What is claimed is:

1. A package comprising:
a first side comprising:
one or more external input/output (I/O) contacts configured to couple electrically to complementary contacts on a substrate; and
one or more internal I/O contacts;
a first metal layer coupling at least one external I/O contact to at least one internal I/O contact;
a first die electrically coupled to at least one internal I/O contact and the first side;
a second side opposite the first side;
an antenna attached to the second side;
a second die positioned between the first metal layer and the second side, the second die electrically coupled to the first die directly by vias with no lateral translation for signal paths between the first die and the second die, the second die electrically coupled to the antenna.

2. The package of claim 1, wherein the one or more external I/O contacts comprise a ball grid array (BGA).

3. The package of claim 1, wherein the second die is coupled to the antenna through second vias with no lateral translation for signal paths between the second die and the antenna.

4. The package of claim 1, wherein the antenna comprises an antenna array.

5. The package of claim 1, further comprising a heat spreader between the second die and the antenna.

6. The package of claim 1, further comprising at least one additional metal layer between the first side and the second side, wherein the second die is positioned in a cavity delimited at least in part by the at least one additional metal layer.

7. The package of claim 1, further comprising dielectric material positioned between metal layers within the package.

8. The package of claim 1, wherein the antenna comprises a patch antenna.

9. The package of claim 1, wherein the first metal layer couples the at least one external I/O contact to at least one internal I/O contact with a conductor having a lateral translation.

10. The package of claim 1, wherein the first die comprises a beam former die.

11. The package of claim 1, wherein the first die is a complementary metal oxide semiconductor (CMOS) die.

12. The package of claim 1, wherein the second die comprises an amplifier die.

13. The package of claim 1, wherein the second die comprises a bipolar junction transistor (BJT).

14. The package of claim 1, wherein the first die comprises a monolithic microwave integrated circuit, MMIC.

15. A wireless communication device comprising:
a baseband processor, BBP;
an antenna package communicatively coupled to the BBP; the antenna package comprising:
a first side comprising:
one or more external input/output (I/O) contacts configured to couple electrically to the BBP through a substrate; and
one or more internal I/O contacts;
a first metal layer coupling at least one external I/O contact to at least one internal I/O contact;
a first die electrically coupled to the one or more internal I/O contacts and the first side;
a second side opposite the first side;
an antenna attached to the second side;
a second die positioned between the first metal layer and the second side, the second die electrically coupled to the first die directly by vias with no lateral translation for signal paths between the first die and the second die, the second die electrically coupled to the antenna.

16. The wireless communication device of claim 15 comprising a base station.

17. The wireless communication device of claim 15, wherein the antenna comprises an antenna array of patch antennas.

18. The wireless communication device of claim 15, wherein the one or more external I/O contacts comprise a ball grid array (BGA).

19. The wireless communication device of claim 15, wherein the second die is coupled to the antenna through second vias with no lateral translation for signal paths between the second die and the antenna.

20. The wireless communication device of claim 15, further comprising a heat spreader between the second die and the antenna.
